(19) United States
(12) Patent Application Publication
(10) Pub. No.: US 2019/0012645 A1
(43) Pub. Date: Jan. 10, 2019

(54) SYSTEM AND METHODS FOR ACCEPTING DUAL FUNCTION PAYMENT CREDENTIAL

(71) Applicant: Mastercard International Incorporated, Purchase, NY (US)

(72) Inventors: Shanthan Subramaniam, Baldwin Place, NY (US); Vitorino Jose Pereira Lopes, Brookfield, CT (US); Sandeep Malhotra, Greenwich, CT (US)

(21) Appl. No.: 16/021,717

(22) Filed: Jun. 28, 2018

Related U.S. Application Data
(60) Provisional application No. 62/528,613, filed on Jul. 5, 2017.

(51) Int. Cl. G06Q 20/02; G06Q 20/40; G06Q 20/26; G06Q 20/20

(52) U.S. Cl. CPC G06Q 20/023; G06Q 20/20; G06Q 20/26; G06Q 20/40

(57) ABSTRACT

A transaction authorization request message is received. The message includes a payment token and a merchant identifier. The payment token is detokenized to detect account mapping for the payment token. From the account mapping, it is determined that a debit transaction option and an ACH (automated clearing house) transaction option exist for the payment token. A selection is made between the debit transaction option and the ACH transaction option based at least in part on the merchant identifier.

### CROSS-REFERENCE TO RELATED APPLICATION

This application claims the benefit of U.S. Provisional Patent Application No. 62/528,613 (filed on Jul. 5, 2017); the contents of which provisional application are hereby incorporated by reference for all purposes.

### BACKGROUND

There are potential advantages that may be realizable by allowing payment transactions (e.g., at a merchant's check-out counter or in an online shopping session) to be completed via an EFT (electronic funds transfer) system such as a fast ACH (automated clearing house) system. However, there may be little motivation for consumers to acquire the ability to effect payment in this manner until a large number of merchants are equipped to accept this type of payment transaction.

The present inventors have now recognized a number of approaches that may facilitate consumer adoption of ACH-based payments for purchase transactions.

### BRIEF DESCRIPTION OF THE DRAWINGS

Features and advantages of some embodiments, and the manner in which the same are accomplished, will become more readily apparent with reference to the following detailed description taken in conjunction with the accompanying drawings, which illustrate exemplary embodiments, wherein:

FIG. 1 is a block diagram illustrating a payment card account system in accordance with some embodiments of the disclosure.

FIG. 2 is a block diagram of an embodiment of a payment network system in accordance with some embodiments of the disclosure.

FIG. 3 is a block diagram illustrating a financial transaction system in accordance with some embodiments of the disclosure.

FIG. 4 is a block diagram that illustrates an example of a computer system that may perform functions in the system of FIG. 3 in accordance with some embodiments of the disclosure.

FIG. 4A is a block diagram that illustrates. an example embodiment of a merchant device shown in FIG. 3.

FIGS. 5 and 6 are flowcharts illustrating processes that may be performed in the system of FIG. 3 in accordance with some embodiments of the disclosure.

### DETAILED DESCRIPTION

In general, and for the purpose of introducing concepts of novel embodiments described herein, a consumer/user may present a payment token or DPAN (digital primary account number) to a merchant to facilitate payment for a purchase transaction. (A DPAN can take a number of forms, such as a payment network card number, a bank account number, a mobile wallet identifier or number, a stored value store number, etc. A bank account number may be tokenized as a payment token or DPAN.) An authorization request that includes the token/DPAN may be routed from the merchant to a payment card network. The payment card network may de-tokenize the token/DPAN and determine that the token/DPAN is potentially routable as either one of a payment card system debit account transaction or an ACH transaction. The payment card network may further determine whether the merchant submitting the authorization request is enrolled in the system for receiving payment via ACH. If so, the payment network may route the transaction for consummation via an ACH system. If not, the transaction may proceed as a conventional payment card system debit account transaction. (The ACH system in question may be one of a number of types, including batch—slow or fast—, immediate, instant, real-time, near real-time, or “faster payments.”)

With this arrangement, consumers may carry and present payment credentials that are usable either for ACH payments or for conventional payment card system debit transactions. The payment credentials may be readily usable at (a) merchants that support debit transactions but not ACH transactions, as well as (b) merchants that support debit transactions and are also enrolled in an ACH system.

Consumers may readily opt-in to enabling ACH transactions with their payment devices, because for a given consumer the same device or credential will continue to be widely accepted as a debit transaction instrument. Accordingly, the barriers to adoption of ACH payment may be low from the point of view of consumers, with a system as described herein.

As an additional feature, merchants that support both debit transactions and ACH payments may be permitted to select for a particular transaction between the two types of payment routings. Other entities associated with merchants, such as acquirers or payment processors, may alternatively make such a selection for the merchant.

Throughout this disclosure, examples of financial transactions will be described, which are not to be taken as limiting. In addition, a number of terms will be used, the use of which terms is not intended to be limiting, but rather the terms are used for convenience and ease of exposition. For example, as used herein, the term “user” may be used interchangeably with the term “consumer” and/or the with the term “cardholder” and these terms are used herein to refer to a person, individual, consumer, customer, company, business or other entity that owns (or is authorized to use) a financial account such as a bank account (i.e., a savings account and/or a checking account) or payment card account (i.e., a credit card account, debit card account, or pre-paid card account) or some other type of financial account (such as a brokerage account, loyalty card account, and/or mass transit access account). In addition, the term “payment card account” may include a credit card account, a debit card account, and/or a deposit account or other type of financial account that an account holder or cardholder may access. The term “payment card account number” includes a number that identifies a payment card system account or a number carried by a payment card, and/or a number that is used to route a transaction in a payment system that handles debit card and/or credit card transactions and the like. Moreover, as used herein the terms “payment card system” or “payment card account system” refer to a system and/or network for processing and/or handling purchase transactions and related transactions, which may be operated by a payment card system operator such as Mastercard International Incorporated, or a similar system. In some embodiments, the term “payment card system” may be limited to systems in which member financial institutions (such as banks) issue payment card accounts to individuals, businesses and/or other entities or organizations (and thus are known as issuer financial institutions or issuer banks). In addition, the terms “payment card system transaction data” and/or “payment card network transaction data” or “payment card transaction data” refer to transaction data associated with payment or purchase transactions that have been or are being processed over and/or by a payment card network or payment card account system. For example, payment card system transaction data may include a number of data records associated with individual payment transactions (or purchase transactions) of cardholders that have been processed over a payment card system or payment card network. In some embodiments, payment card system transaction data may include information such as data that identifies a cardholder, data that identifies a cardholder's payment device and/or payment card account, transaction date and time data, transaction amount data, an indication of the merchandise or services that have been purchased, and information identifying a merchant and/or a merchant category. Additional transaction details and/or transaction data may also be available and/or utilized for various purposes in some embodiments.

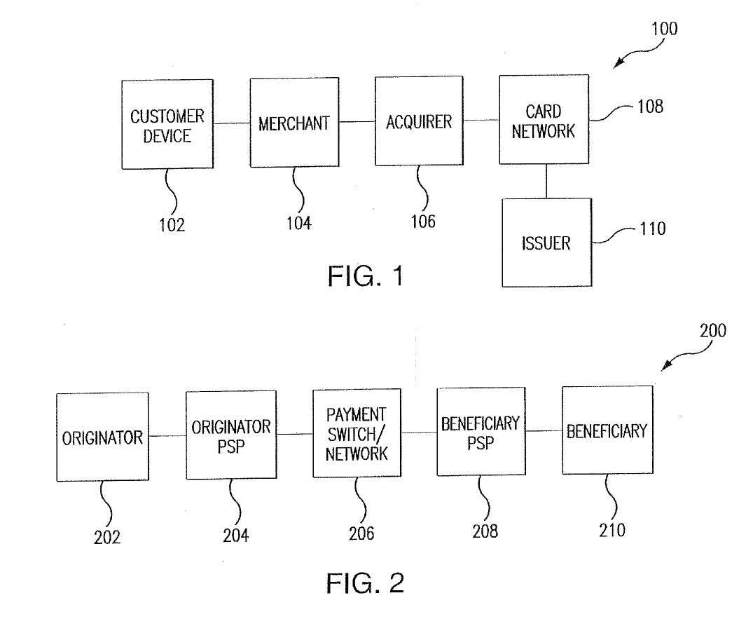

FIG. 1 is a block diagram that illustrates a payment card system 100. The payment card system 100 includes a customer device 102 such as a magnetic stripe card, a payment IC (integrated circuit) card (contactless and/or contact), or a payment-enabled mobile device (such as a smartphone that includes a payment application), a merchant device 104, an acquirer financial institution (FI) computer 106, a card network 108, and an issuer FI computer 110.

The merchant device 104 may be, for example, a POS (point of sale) terminal/card reader or a merchant mobile device (i.e., a smartphone), and may also be considered part of the payment card account system 100. The customer device 102 may be presented to the merchant device 104 to consummate a purchase transaction and to permit the merchant device 104 to read payment card account data (including, for example, a payment account number) from the customer device 102. In other situations, the merchant device 104 may be an e-commerce server computer, and the customer device 102 may be a personal computer or a mobile device running mobile browser software or the like. In this case, the customer device 102 may engage in an online shopping session with an e-commerce website hosted by the merchant device 104. In the case of an e-commerce transaction, the merchant website may switch the user to the internet banking portal operated by the user's bank, which may engage in a user authentication process and then present the user's payment credentials to the merchant's e-commerce computer. As another alternative, an e-commerce transaction may be effected “in-app” via the user's mobile device.

During a purchase transaction, the acquirer FI computer 106 may receive a payment account system authorization request message for the transaction from the merchant device 104. The acquirer FI computer 106 may then route the authorization request message via a card network 108 to an issuer FI computer 110, which is operated by the issuer of a payment account that is associated with the account number obtained by the merchant device 104 (e.g., from the customer device 102) and included in the authorization request message. In some implementations, the authorization response message generated by the payment issuer server computer 110 is routed back to the merchant device 104 via the card network 108 and the acquirer FI computer 106.

One well known example of a payment card network is referred to as the “Banknet” system, and is operated by Mastercard International Incorporated, the assignee of the present application.

Referring again to FIG. 1, the payment account issuer FI computer 110 may be operated by or on behalf of a financial institution, such as a bank, that issues payment accounts to individual users (such as the customer or consumer who presented or operated the customer device 102 referred to above). For example, the payment card issuer FI computer 110 may perform such functions as (a) receiving and responding to requests for authorization of payment account transactions to be charged to payment accounts issued by the FI; and (b) tracking and storing transactions and maintaining account records.

The payment card account system communications among the merchants, acquirers, card network and/or issuers may conform to a known standard such as ISO 8583.

It should be understood that the components shown in the system 100 of FIG. 1 are only those that are needed for processing a single transaction. However, a typical or practical payment system may process hundreds, thousands or more purchase transactions per day (including simultaneous transactions), and thus may include a considerable number of payment account issuers and their computers and/or computer networks, a considerable number of acquirers and their computers and/or computer networks, and numerous merchants and their devices, as well as a very large number of customer devices.

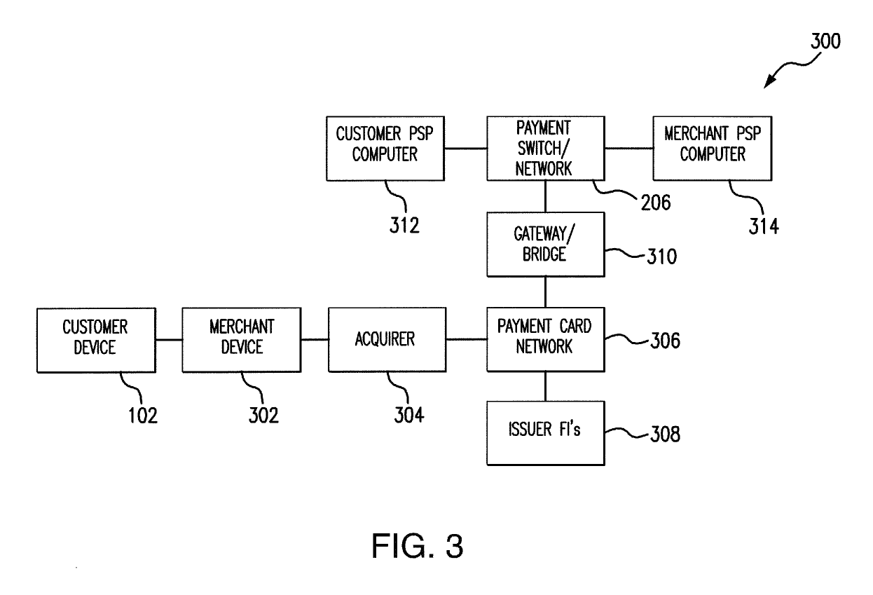

FIG. 2 is a block diagram illustrating a payment network system 200, of which one example is an ACH (automated clearing house) system of a kind operated in the United States. The payment network system 200 includes an originator device 202, for example, a computer operated by an originator of a transaction. Common kinds of transactions handled by the payment network system 200 include credit transactions and debit transactions (not to be confused with payment card system debit account transactions), wherein the originator 202 is the party that initiates the transaction. The originator may be, for example, an individual or a corporation or other organization or entity.

Referring again to FIG. 2, the payment network system 200 also includes an originator PSP (payment services provider) computer 204. The originator PSP computer 204 receives payment instructions from the originator and forwards data entries that reflect the instructions to a payment system switch/network 206, which is also part of the payment network system 200. The originator PSP computer 204 may be operated by an originator PSP (which may be, for example, an originating depository financial institution or “ODFI”) of which the originator is a customer. In some embodiments, the switch/network 206 can be operated by a government agency or a private entity that serves as a clearing facility for the system 200.

Also included in the system 200 is a beneficiary PSP computer 208 (which may be, for example, a receiving depository financial institution or “RDFI”). The beneficiary PSP computer 208 receives entries from the payment system switch/network 206 and posts entries to accounts of depositors.

Still further, the system 200 includes a beneficiary 210 that is one of the depositors of the beneficiary PSP. In the case of a credit transaction, the account at the beneficiary PSP of the beneficiary may be credited with the amount instructed to be paid by the originator device 202. The beneficiary may be, for example, an individual or a corporation or other organization. Both the originator and beneficiary PSPs may be banks or other types of financial institutions (FIs).

The communications among the parties in the payment network system 200 may typically be conducted using XML (eXtensible Markup Language) and may comply with a standard according to ISO 20022.

It should be understood that the components of the system 200 as depicted in FIG. 2 are only those that are needed for processing a single transaction. However, a typical payment network system 200 may process many transactions (including simultaneous transactions) and therefore may include a considerable number of PSPs and their computers and/or computer networks, one or more clearing operators, and numerous originators and beneficiaries.

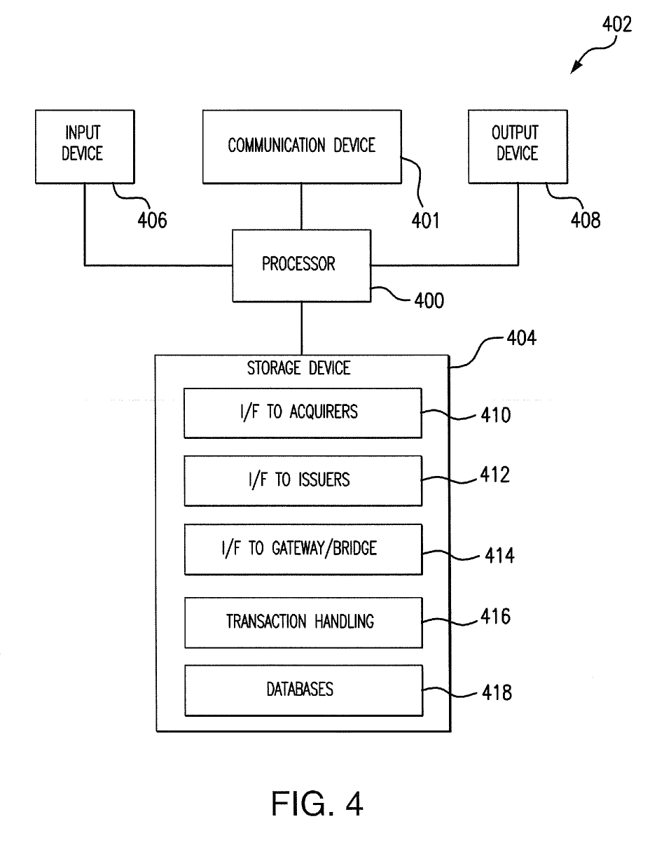

FIG. 3 is a block diagram illustrating a financial transaction system 300 in accordance with some embodiments.

As in FIG. 1, a customer device 102 is shown. The customer device 102 may be a typical payment-enabled smartphone, as are well-known. Alternatively, the customer device 102 may be a payment card such as a contactless IC (integrated circuit) payment card, a contact IC payment card and/or a magnetic stripe card. The customer device 102 may be in other form factors as well, such as a fob or wristband. The customer device 102, in whatever form, may have been provisioned/personalized with a token/DPAN in a standard format for a payment card account number. In some embodiments or situations, the customer device may be a personal computer or a mobile device that runs a browser, and may be operable to engage in online shopping transactions.

The system 300 further includes a merchant device 302 such as a point of sale terminal or an e-commerce server computer. The merchant device 302 may exhibit typical functionality of such devices, and may have additional capabilities as well, as described herein. The user (not shown) may use the consumer device 102 to initiate a payment transaction by interacting with/being presented to the merchant device 302.

In addition, the system 300 includes an acquirer 304 that is in communication with the merchant device 302. The acquirer 304 may perform the same functions as described above in connection with FIG. 1, and may have additional capabilities as well, as described herein.

Still further, the system 300 includes a payment card network 306. Details of functionality of the payment card network 306, as provided in accordance with aspects of the present disclosure, will be discussed below. In addition to functionality described herein according to aspects of this disclosure, the payment card network 306 may exhibit all functionality associated with typical card networks, such as the card network 108 shown in FIG. 1.

Also included in the system 300 (FIG. 3) are issuer financial institutions (FIs) 308, which may be akin to the issuer 110 discussed above in connection with FIG. 1. As was the case in the system of FIG. 1, payment card account transaction authorization request messages may be routed to the issuer FIs 308 via the payment card network 306.

A gateway/bridge computer 310 is shown operably connected between the payment card network 306 and a payment switch/network 206. It should be understood, however, that in some embodiments the gateway computer 310 may be a component or components associated with and/or provided by and/or operated by the operator of the payment card network 108. In some embodiments, the gateway computer 310 may function as a transaction message switching computer and may provide protocol and/or message translation at one or more conceptual and/or physical levels.

In addition to the payment switch/network 206, a merchant PSP 314 (corresponding to the block 208 shown in FIG. 2) and a customer PSP computer 312 (corresponding to the block 204 shown in FIG. 2) are also shown as components of the system 300. It is to be understood that blocks 312, 206 and 314 shown in FIG. 3 are also components of an ACH system, which may exhibit functionality typical of such systems. Preferably, the ACH system may be of the “fast” or “real time” type, so that immediate transfers of funds are made therein. In some embodiments, the customer PSP computer 312 may correspond to, overlap with or be associated with the one of the issuer FI's—i.e., the issuer which issued the customer device 102 or caused the customer device 102 to be personalized with the user's payment credentials. In some embodiments, the merchant PSP computer 314 may correspond to, overlap with or be associated with the acquirer 304.

Each block shown in FIG. 3 that represents an entity should also be understood to represent a computer or computing device operated by or on behalf of the entity. Each such computer or computing device may include a processor and a memory that stores program instructions to cause the computer or computing device to provide functionality as described herein.

It should be understood that, for ease of understanding, a minimal number of components are shown in the financial transaction system 300 of FIG. 3. However, a practical embodiment of a financial transaction system 300 may process many transactions (including simultaneous transactions) and therefore may include one or more payment card networks 306, numerous acquirers 304 (and computers operated by or for acquirers), numerous issuer FIs 308, one or more gateway/bridge computers 310, one or more payment switch/network computers 206, and numerous customer PSP computers 312 and merchant PSP computers 314. In addition, numerous customer devices 102 and merchant devices 302 may be involved.

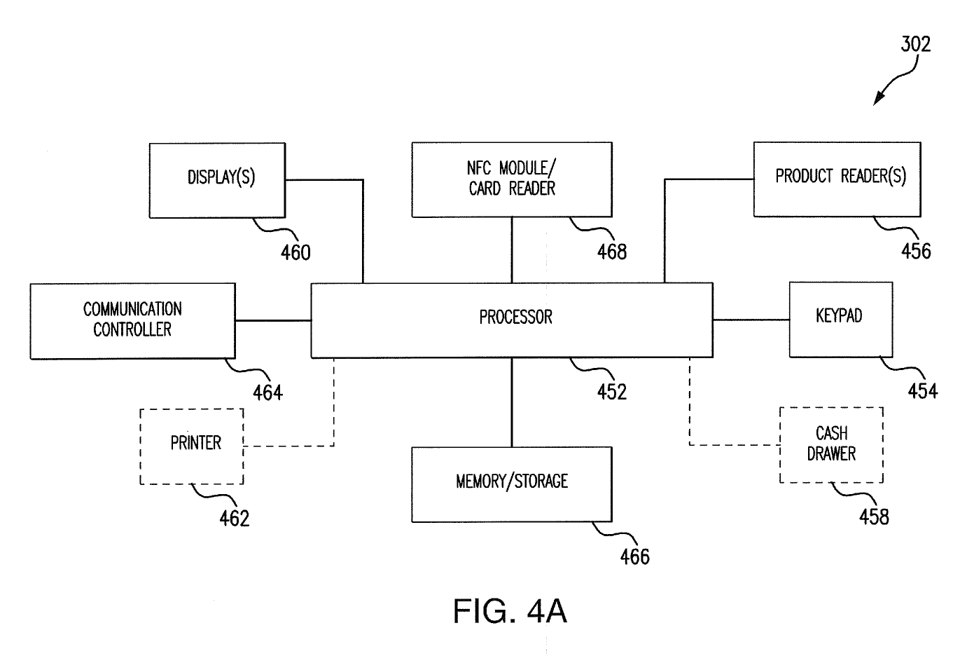

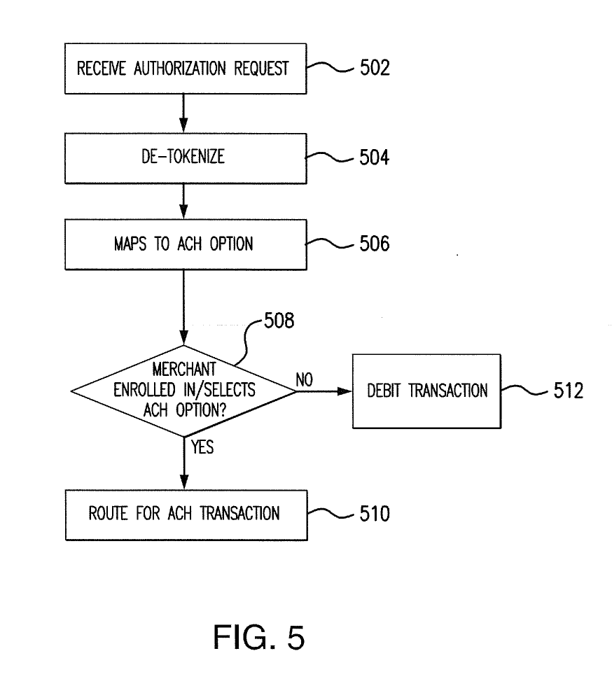

FIG. 4 is a block diagram of an example computer system 402 that may perform functions in the payment system of FIG. 3. The computer system 402 may be operated by the payment card network 306, and may accordingly be referred to hereinafter as a “payment card network computer.”

Referring now to FIG. 4, the payment card network computer 402 may, in its hardware aspects, resemble a typical server computer and/or mainframe computer, but may be controlled by software to cause it to function as described herein.

The payment card network computer 402 may include a computer processor 400 operatively coupled to a communication device 401, a storage device 404, an input device 406 and an output device 408. The communications device 401, the storage device 404, the input device 406 and the output device 408 may all be in communication with the processor 400.

The computer processor 400 may be constituted by one or more processors. Processor 400 operates to execute processor-executable steps, contained in program instructions described below, so as to control the payment card network computer 402 to provide desired functionality.

Communication device 401 may be used to facilitate communication with, for example, other devices (such as other components of the payment system 300). Communication device 401 may comprise numerous communication ports (not separately shown), to allow the payment card network computer 402 to communicate simultaneously with a number of other computers and other devices, including communications as required to simultaneously handle numerous requests for payment transactions.

Input device 406 may comprise one or more of any type of peripheral device typically used to input data into a computer. For example, the input device 406 may include a keyboard and a mouse. Output device 408 may comprise, for example, a display and/or a printer.

Storage device 404 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 404 stores one or more programs for controlling processor 400. The programs comprise program instructions (which may be referred to as computer readable program code means) that contain processor-executable process steps of the payment card network computer 402, executed by the processor 400, to cause the payment card network computer 402 to function as described herein.

The programs may include one or more conventional operating systems (not shown) that control the processor 400 so as to manage and coordinate activities and sharing of resources in the payment card network computer 402, and to serve as a host for application programs (described below) that run on the payment card network computer 402.

The programs stored in the storage device 404 may include, for example, a software interface 410 that supports communications between the payment card network computer 402 and numerous acquirers that provide payment acceptance services to many merchants.

The programs stored in the storage device 404 may also include a software interface 412 that supports communication between the payment card network computer 402 and the issuer FIs 308 shown in FIG. 3.

Continuing to refer to FIG. 4, the storage device 404 may further store a software interface 414 that supports communications between the payment card network computer 402 and the gateway/bridge computer 310 shown in FIG. 3.

Still further, and continuing to refer to FIG. 4, the storage device 404 may store a transaction handling application program 416. The transaction handling application program 416 may operate to handle payment transactions requested by authorization requests, as described further below.

The storage device 404 may also store, and the payment card network computer 402 may also execute, other programs, which are not shown. For example, such programs may include communications software and a reporting application. The latter program may respond to requests from system administrators for reports on the activities performed by the payment card network computer 402. The other programs may also include, e.g., device drivers, database management software, etc.

The storage device 404 may also store one or more databases 418 needed for operation of the payment card network computer 402.

FIG. 4A is a block diagram that illustrates an example embodiment of the merchant device 302 shown in FIG. 3. The merchant device 302 may be embodied as a POS (point of sale) terminal, and may provide functionality as described herein in connection with optionally routing payment transactions for execution via an ACH system.

The merchant device 302 may include a processing element (or elements) such as the processor 452 shown in FIG. 4A. The processor 452 may, for example, be a conventional microprocessor, and may operate to control the overall functioning of the merchant device 302.

The merchant device 302 may also include conventional peripheral components, in communication with and/or controlled by the processor 452, such as: (a) a keypad 454 for receiving input from the human operator of the merchant device 302; (b) a product reader 456 for reading any form of unique product identifier, such as a barcode or RFID, that appears on, or is attached to, products brought to the merchant device 302 for purchase; (c) a cash drawer 458 for storing cash received from customers; (d) one or more displays 460 for providing output (e.g., identifying products presented for purchase and their prices, indicating sales tax due, indicating transaction subtotals and totals, etc., providing prompts to the customer and/or to the sales associate); (e) a printer 462 for printing out sales receipts; and (f) a communication controller 464 for allowing the processor 452, and hence, the merchant device 302 to engage in communication over data networks with other devices (e.g., with a computer operated by a transaction acquirer/transaction processor). (In some embodiments, at least one of the displays 460 may be a touch screen, so as to provide an input function as well as an output function.)

In addition, the merchant device 302 may include one or more memory and/or data storage devices (indicated collectively at 466), which may comprise any combination of one or more of a hard disk drive, RAM (random access memory), ROM (read only memory), flash memory, etc. The memory/data storage device(s) 466 may store software and/or firmware that programs the processor 452 and the merchant device 302 to perform functionality commonly provided by POS devices. Thus the memory/data storage device(s) 466 may be in communication with the processor 452. Further, the merchant device 302 may include one or more housings (not shown) which contain and/or support one or more of the other components shown in FIG. 4A.

To enable acquisition of account data from the customer device 102 (FIG. 3), merchant device 302 may include one or more device readers (block 468), which may include an NFC module for interacting with payment-enabled mobile devices and/or suitable additional reader components such as, for example, a magnetic stripe card reader, a contactless IC payment card reader and/or a contact IC payment card reader.

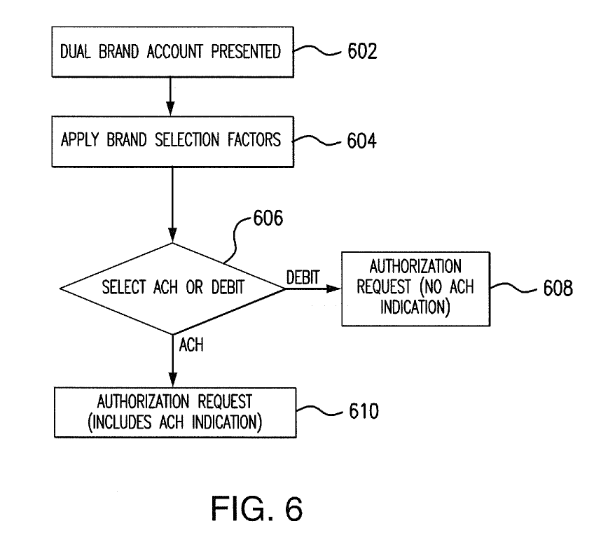

FIG. 5 is a flowchart illustrating processes that may be performed in the system of FIG. 3 in accordance with some embodiments of the disclosure. In particular, at least some aspects of the process of FIG. 5 may be performed in and/or by the payment card network computer 402.

At 502 in FIG. 5, the payment card network computer 402 may receive an authorization request. For present purposes, it may be assumed that the authorization request contains a token/DPAN that was presented by the customer device 102 to the merchant device 302. It may be further assumed that the authorization request originated from the merchant device 302 and was routed to the payment card network computer 402 via the acquirer 304. Still further, it may be assumed that the token/DPAN belongs to an individual user who has enrolled in an ACH payment service administered by the payment card network 306 and also has been issued a payment card system debit account by his/her issuer bank. Still further, administrative steps had previously been taken to associate the token/DPAN with the user's debit account and with the ACH service offering with reference to the user's bank deposit account that is also accessible via the debit account.

At 504 in FIG. 5, the payment card network computer 402 de-tokenizes the token/DPAN so that the mapping to the user's accounts is retrieved.

At 506, the payment card network computer 402 detects that the de-tokenized token/DPAN is mapped to the ACH service offering, such that, at least potentially, there is the option of completing the payment transaction via ACH.

A decision block 508 may follow block 506 in the process of FIG. 5. At decision block 508, the payment card network computer 402 may determine—based at least in part on the merchant identifier included in the authorization request—whether the merchant in question has enrolled in the ACH service offering. (As will be seen, the determination at 508 may also take into account—in some situations or some embodiments—whether the merchant, or a party associated with the merchant, has elected to have the particular transaction completed via ACH). If a positive determination is made at decision block 508 (i.e., if the payment card network computer 402 determines that the merchant is enrolled in the ACH service offering), then block 510 may follow decision block 508. At block 510, the payment card network computer 402 may route the authorization request for completion via an ACH transaction. If this occurs, the payment card network computer 402 may send the authorization request (including the consumer's and merchant's banking details)—or a corresponding message—to the gateway/bridge computer 310. The gateway/bridge computer 310 may then perform a suitable translation of the authorization request or message, and proceed to trigger an ACH transaction via messaging to the payment switch/network 206. As a result of the messaging from the gateway/bridge computer 310, the appropriate transaction amount may be transferred from the consumer's bank account to the merchant PSP/acquirer. Depending on the arrangements between the acquirer and the merchant, the transaction amount (possibly net of applicable fee/discount) may be immediately transferred into the merchant's bank account. Again depending on the nature of the ACH network and on arrangements between the acquirer and the merchant, the merchant may obtain immediate availability of the funds transferred for the purchase transaction.

Referring again to decision block 508, if a negative determination is made at that decision block (i.e., if the payment card network computer 402 determines that the merchant has not enrolled in the ACH service offering), then block 512 may follow decision block 508. At block 512, the payment card network computer 402 may handle the authorization request essentially as a conventional authorization request for a payment card system debit account transaction. In other words, the authorization request may be routed to the issuer of the user's payment card system debit account, and the transaction may be charged to the user's bank account like a conventional payment card system debit account transaction. The funds—in this case—may be made available to the merchant in accordance with conventional clearing and acquirer-to-merchant disbursement practices.

With a system as described herein, which maps a given token/DPAN to either ACH routing or payment card system routing, consumers may find it convenient to migrate to an ACH service offering, because their payment device/credential will be widely accepted for conventional payment card system debit transactions at merchant locations that are not enrolled in the ACH service offering. Thus consumers will not face a penalty in convenience for adoption of the ACH service offering. Further, facilitation of adoption by consumers of the ACH service offering may benefit merchants, who may receive more rapid access to funds for transactions handled via ACH.

It has been noted above that, in some embodiments, if a merchant is enrolled in the ACH service offering and also supports conventional payment card system debit account transactions, then it may be the case that the merchant (or a party associated with the merchant) may be permitted to elect for a given payment transaction whether the transaction is to be processed via the ACH system or alternatively as a payment card system debit account transaction. Further discussion of this subject will now proceed with reference to FIG. 6.

FIG. 6 is a flowchart illustrating processes that may be performed in the system of FIG. 3 in accordance with some embodiments of the disclosure. In particular, at least some aspects of the process of FIG. 6 may be performed in and/or by the merchant device 302 (or by the acquirer 304, or by a transaction processor—not shown—that serves the merchant or the acquirer).

At 602 in FIG. 6, the customer device 102 presents a token/DPAN to the merchant device 302, where the token/DPAN reflects the customer's enrollment in the ACH system, while also being associated with a payment card system debit account owned by the customer. It is assumed in connection with block 602 that the merchant device 302 receives the token/DPAN from the customer device 102. Communication/data transfer from the customer device 102 to the merchant device 302 may also include an indication that the token/DPAN is “dual function” as indicated above (i.e., presentable for either ACH processing or for initiating a payment card system debit account transaction).

In response to receiving the “dual function” indication (and assuming that the merchant is enrolled in the ACH service offering), then the processing in the merchant device 302 may advance from block 602 to block 604. At block 604, the merchant device 302 may apply one or more factors in making a determination as to whether to elect ACH processing or payment card system debit transaction processing for the current transaction. The factors considered may include, for example, one or more of (1) how quickly the transaction would be handled in one optional route versus the other, (2) the relative quality/reliability of the ACH network versus the payment card system “rails”, (3) the relative costs of the two routing options, and (4) the ability of one or the other or both routing options to be associated with value-added services (e.g., compatibility with the merchant's customer loyalty program). In various embodiments, the decision process may be relatively simple or relatively complex, depending on the preferences and needs of the merchant.

Decision block 606 follows block 604 in FIG. 6. Decision block 606 represents the outcome of the consideration of factors as described above in connection with block 604. At block 604, the merchant device 302 determines whether to select ACH routing or payment card system debit account transaction routing for the current transaction. If the merchant device 302 selects payment card system debit account transaction routing at decision block 606, then the process of FIG. 6 advances from decision block 606 to block 608. At block 608, the merchant device generates a conventional authorization request for a payment card system debit account transaction. If the merchant device 302 selects ACH processing at decision block 606, then the process of FIG. 6 advances from decision block 606 to block 610. At block 610, the merchant device generates an authorization request that includes an indication that ACH processing has been selected. (From previous discussion, it will be appreciated that the downstream handling of the authorization request in the latter case may result in the payment card network 306 honoring the selection made by the merchant device 302. If the process happens to branch to block 608, then no such ACH processing indication is included in the resulting authorization request.)

In the case of either block 608 or block 610, it will be understood that the authorization request generated in the block is transmitted by the merchant device 302 to the acquirer 304 for routing to the payment card network 306.

In the above discussion of FIG. 6, it was assumed that automated/programmed decision making occurred relative to the ACH versus payment card system debit account transaction selection. However, in some situations, or in some embodiments, a human being interacting with the merchant device 302 may provide input to make the selection. The human being may be, for example, an employee of the merchant, or the customer.

It may be the case for transactions in the system of FIG. 3 that are handled through ACH transactions that a set of rules or features applies. In some embodiments, the set of rules or features may be parallel to rules or features commonly offered with payment card system debit account products. Among the features associated with the ACH-routed transactions may be purchase protection, liability protection, lost or delayed luggage support and/or services, and so forth.

It is contemplated that consumers may opt in to the ACH service offering via their banks. Merchants may opt in to the ACH service offering either through their acquirers or through an enrollment process that may be provided by the payment card network operator.

In some embodiments, transaction messaging referred to herein is performed in real time, or near-real time. In other embodiments, at least some messages are transferred in batch processes, such as daily delivery of batches of messages for posting transactions to accounts.

In examples described above, a merchant device or a party associated with a merchant decides as to whether a requested transaction is to be handled as an ACH transaction or as a conventional payment card network transactions. However, in other embodiments, such a decision may be made at the payment card network computer 402. The decision at the payment card network computer 402 may be based on one or more factors, such as relative costs of the ACH option versus the payment card network option, and/or relative processing speeds or other execution characteristics of the respective transaction processing systems.

In the case of either execution by ACH or by the payment card network, a suitable authorization response/reply message may be sent from the customer's issuer FI 308 (FIG. 3) or customer PSP 312, as the case may be, to the merchant device 302.

Teachings of this disclosure may be applied in card or account acceptance environments that currently exist or have been proposed or may be proposed in the future; such environments may include merchant points of interaction including online, in-app, or in-store, and may include data transfer mechanisms in-store that include contact chip card reading; magnetic card swiping; proximity reading of contactless cards, fobs, payment-enabled mobile devices, etc.; and/or payment transactions launched by reading of QR (quick response) codes.

The above descriptions and illustrations of processes herein should not be considered to imply a fixed order for performing the process steps. Rather, the process steps may be performed in any order that is practicable, including the omission of one or more steps and/or the simultaneous performance of at least some steps.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

Although the present disclosure has been described in connection with specific exemplary embodiments, it should be understood that various changes, substitutions, and alterations would be apparent to those skilled in the art and can be made to the disclosed embodiments without departing from the spirit and scope of the disclosure as set forth in the appended claims.

What is claimed is:

1. A method comprising:
receiving a transaction authorization request message, the message including a payment token and a merchant identifier;
detokenizing the payment token to detect account mapping for the payment token;
determining from the account mapping that a debit transaction option and an ACH (automated clearing house) transaction option exist for the payment token; and
selecting between the debit transaction option and the ACH transaction option based at least in part on the merchant identifier.

2. The method of claim 1, further comprising:
determining that a merchant identified by the merchant identifier is enrolled for ACH transactions.

3. The method of claim 1, further comprising:
receiving an indication from a merchant identified by the merchant identifier to select the ACH transaction option.

4. The method of claim 1, further comprising:
receiving an indication from a merchant identified by the merchant identifier to select the debit transaction option.

5. The method of claim 1, wherein said selecting is based at least in part on respective costs of said options.

6. The method of claim 1, wherein said selecting is based at least in part on respective processing speeds of said options.

7. The method of claim 6, wherein said selecting is based in part on respective costs of said options.

8. The method of claim 1, further comprising:
executing a payment transaction according to a selected one of said options.

9. A method comprising:
receiving account data at a merchant device, the account data including a payment token and an indication that an ACH (automated clearing house) transaction option is available;
applying at least one option selection factor; and
based on the applied at least one option selection factor, selecting said ACH transaction option.

10. The method of claim 9, further comprising:
generating and transmitting, by the merchant device, a transaction authorization request message, the transaction authorization request message indicating selection of said ACH transaction option.

11. The method of claim 10, wherein the transaction authorization request message is in a standard messaging format used in a payment card account network.

12. The method of claim 11, wherein the merchant device is a point of sale (POS) terminal.

13. The method of claim 9, wherein said at least one option selection factor is a cost of said ACH transaction option.

14. The method of claim 9, wherein said at least one option selection factor is a speed of execution of said ACH transaction option

15. An apparatus comprising:
a processor; and
a memory in communication with the processor, the memory storing program instructions, the processor operative with the program instructions to perform functions as follows:
receiving a transaction authorization request message, the message including a payment token and a merchant identifier;
detokenizing the payment token to detect account mapping for the payment token;
determining from the account mapping that a debit transaction option and an ACH (automated clearing house) transaction option exist for the payment token; and
selecting between the debit transaction option and the ACH transaction option based at least in part on the merchant identifier.

16. The apparatus of claim 15, wherein the processor is further operative with the program instructions to determine that a merchant identified by the merchant identifier is enrolled for ACH transactions.

17. The apparatus of claim 15, wherein the processor is further operative with the program instructions to receive an indication from a merchant identified by the merchant identifier to select the ACH transaction option.

18. The apparatus of claim 15, wherein the processor is further operative with the program instructions to receive an indication from a merchant identified by the merchant identifier to select the debit transaction option.

19. The apparatus of claim 15, wherein said selecting is based at least in part on respective costs of said options.

20. The apparatus of claim 15, wherein said selecting is based at least in part on respective processing speeds of said options.
